(19) United States
(12) Patent Application Publication
(10) Pub. No.: US 2025/0341819 A1
(43) Pub. Date: Nov. 6, 2025

(54) INTELLIGENT IDENTIFICATION DEVICE FOR HANDHELD INTERCHANGEABLE POWER TOOL

(71) Applicant: DARREN WANG, Irvine, CA (US)

(72) Inventor: DARREN WANG, Irvine, CA (US)

(21) Appl. No.: 18/653,949

(22) Filed: May 2, 2024

(51) Int. Cl. G05B 19/418

(52) U.S. Cl. CPC G05B 19/4183; G05B 19/41845; G05B 2219/49304

(57) ABSTRACT

An intelligent identification device for handheld interchangeable power tools includes an MCU control unit installed in an electric body. The MCU control unit is electrically connected to a power supply unit and a drive unit in the electric body. The MCU control unit controls and adjusts the output power of the drive unit. An ID recognition module is installed at a connecting end of the electric body. An ID module is installed on the electric working head which is detachably assembled to the connecting end of the electric body. The drive unit is operatively engaged with the electric working head. The ID module and the ID recognition module are signally disconnected or connected depending on the detachment or assembly of the electric working head relative to the connecting end. This intelligent identification device automatically senses and identifies different types of electric work heads to control the power tool.

### FIELD OF THE INVENTION

The present invention relates to a power tool, and more particularly, to an intelligent identification device for handheld interchangeable power tool.

### BACKGROUND OF THE INVENTION

In the field of power tools, in order to meet the diverse needs of customers, handheld interchangeable power tools have emerged, such as Taiwan Patent No. M270894 discloses “Replacement Adapter for Power Tools”. In addition to screwing screws, electric screwdrivers can also accommodate drill bit attachments, thus providing both screwdriver and drill functionalities. However, the range of tools suitable for powered operation by electric tools is not limited to just screwdrivers and drills. More and more functional tool heads can be powered and utilized by electric tools. However, these types of power tools only achieve safety limitations by simply restricting tool operation through mechanical switches controlled by mechanical structures. Yet, after changing to different tool heads, there is no adaptive adjustment of transmission control based on the different performance of the work heads. That is to say, after replacing different types of tool heads, only fixed power output is provided through the transmission of the power tool, ignoring the power requirements for each type of work head and thus failing to fully utilize the tool's capabilities.

The present invention intends to provide an intelligent identification device for handheld interchangeable power tools to eliminate the shortcomings mentioned above.

### SUMMARY OF THE INVENTION

The present invention relates to an intelligent identification device for handheld interchangeable power tools, and comprises an MCU control unit installed within an electric body which includes a power supply unit and a drive unit. The MCU control unit is electrically connected to the power supply unit and the drive unit. The power supply unit provides power to the MCU control unit and the drive unit. The MCU control unit controls and adjusts the output power of the drive unit. An ID recognition module is connected to a connecting end of the electric body, and is electrically connected to the MCU control unit. An ID module is installed to an electric working head which is detachably assembled to the connecting end of the electric body. The drive unit is operatively engaged with the electric working head and drives the electric working head. The ID module and the ID recognition module are signally disconnected or connected according to detachment or assembly of the electric working head relative to the connecting end. An ID data unit is located within the electric body and electrically connected to the MCU control unit. The ID data unit includes multiple data messages. Each data message represents drive data for different types of electric working heads.

When different types of electric working heads are replaced and installed at the connecting end of the electric body, the ID module of each electric working head is signally connected to the ID recognition module. The ID recognition module sends a generated signal to the ID data unit through the MCU control unit for judgment and recognition. The ID data unit selects a matching data, and the drive unit is powered and driven according to the selected matching data through the MCU control unit.

The primary object of the present invention is to automatically sense and identify different types of work heads, thereby controlling the power tool to provide appropriate driving power and unleashing the optimal driving performance for each type of tool head. This improves upon prior art where power tools were only capable of controlling various work heads with fixed driving power, thus unable to maximize the optimal driving performance for each type of tool head.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a block diagram of the present invention.

FIG. 2 is an exploded view of the electric body and the first type of electric working head of the present invention, and

FIG. 3 is an exploded view of the electric body and the second type of electric working head of the present invention.

### DETAILED DESCRIPTION OF THE PREFERRED EMBODIMENT

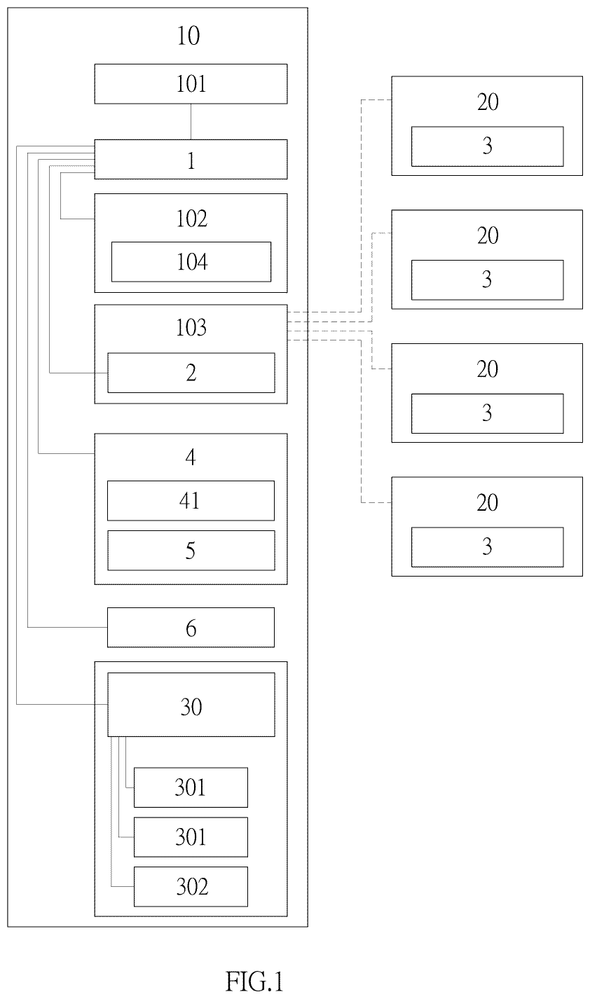

Referring to FIGS. 1 to 3, the intelligent identification device for handheld interchangeable power tools of the present invention comprises an MCU control unit 1 installed within an electric body 10. The electric body 10 includes a power supply unit 101 and a drive unit 102. The MCU control unit 1 is electrically connected to the power supply unit 101 and the drive unit 102, wherein the power supply unit 101 provides power to the MCU control unit 1 and the drive unit 102. The MCU control unit 1 controls and adjusts an output power of the drive unit 102. An ID recognition module 2 is connected to a connecting end 103 of the electric body 10. The ID recognition module 2 is electrically connected to the MCU control unit 1. An ID module 3 is installed to an electric working head 20 which is detachably assembled to the connecting end 103 of the electric body 10. The drive unit 102 is operatively engaged with the electric working head 20 and drives the electric working head 20, wherein the ID module 3 and the ID recognition module 2 are signally disconnected or connected according to detachment or assembly of the electric working head 20 relative to the connecting end 103. The drive unit 102 further comprises a drive shaft rod 104 protruding from the connecting end 103. The electric working head 20 is operatively coupled to the drive shaft rod 104, such that the rotation of the drive shaft rod 104 drives the electric working head 20. An ID data unit 4 is located within the electric body 10 and electrically connected to the MCU control unit 1. The ID data unit 4 includes multiple data messages 41, and each data message 41 represents drive data for different types of electric working heads 20. For example, it can withstand applicable voltage, current, torque, impact force, etc. When different types of electric working heads 20 are replaced and installed at the connecting end 103 of the electric body 10, the ID module 3 of each electric working head 20 is signally connected to the ID recognition module 2. The ID recognition module 2 sends a generated signal to the ID data unit 4 through the MCU control unit 1 for judgment and recognition. The ID data unit 4 selects a matching data, and the drive unit 102 is powered and driven according to the selected matching data through the MCU control unit 1.

Users can select the electric working head 20 they want to use according to the working environment. After installing and coupling the electric working head 20 onto the drive shaft rod 104 located at the connecting end 103, the ID module 3 in the electric working head 20 will form a signal-transmitting state with the ID recognition module 2 in the electric body 10. When the connection between the ID recognition module 2 and the ID module 3 is established, a signal matching the installed electric working head 20 will be generated. At this point, the signal will be transmitted to the MCU control unit 1 through the ID recognition module 2. The MCU control unit 1 will compare the signal with the multiple data messages 41 in the ID data unit 4, match the corresponding signal with the selected data message 41. When confirm the match, then adjust the power output (voltage, current) from the power supply unit 101 and the driving force (torque, impact force, rotation speed, etc.) from the drive unit 102 accordingly. This allows for the proper driving of accessories (such as screws, rivets, etc.) as needed.

As explained above, each type of electric working head 20 can receive the most suitable driving force after being installed on the electric body 10, without the need for manual adjustments by the user. This intelligent control not only ensures the safety of the operator during operation, preventing inappropriate driving force that could lead to overdriving or excessive impact, but also prevents issues such as insufficient driving force resulting in incomplete joining (e.g., loose screws, inadequate riveting). In addition, it ensures the prolonged operational use of both the electric working head 20 and the electric body 10.

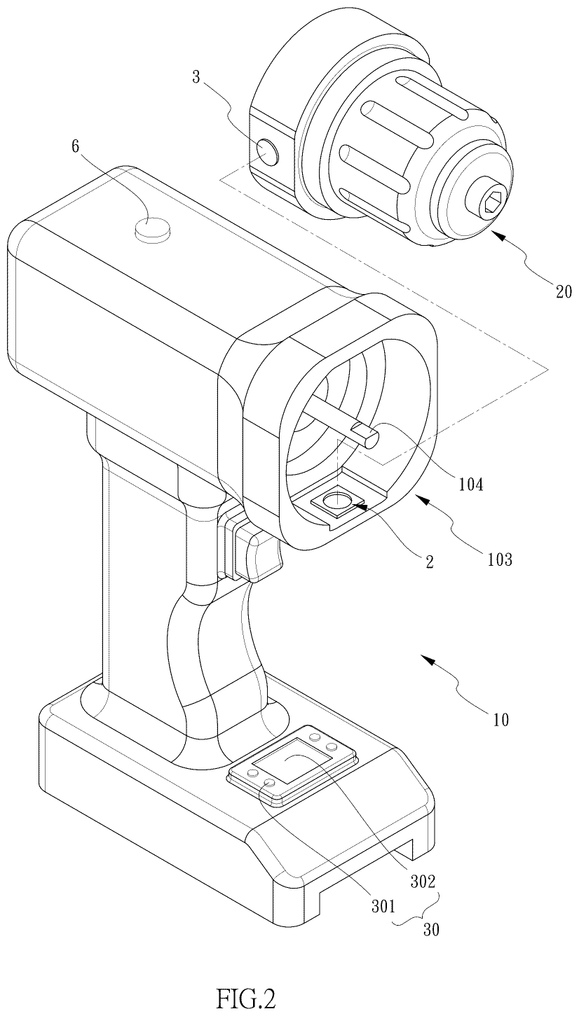

The combination of the electric working head 20 and the electric body 10 in the present invention can mainly be divided into two types. Firstly, as shown in FIG. 2, after installing the electric working head 20 to the electric body 10, the signal connection between the ID recognition module 2 and the ID module 3 is non-contact. The non-contact type can include wireless radio frequency identification systems (RFID), NearFi couplers, or NSD position sensors (these are enumerated examples, not intended to limit the types to the three mentioned). For instance, when the ID recognition module 2 and the ID module 3 are RFID systems, the radio frequency read-write function of the RFID system is used to match specific signals with the multiple data messages 41 in the ID data unit 4 via the MCU control unit 1. From the matched data messages 41, the appropriate driving specifications needed for the electric working head 20 are determined. Then, the MCU control unit 1 adjusts the driving of the electric working head 20 based on the matched data messages 41, allowing the electric working head 20 to operate according to the matched data messages 41.

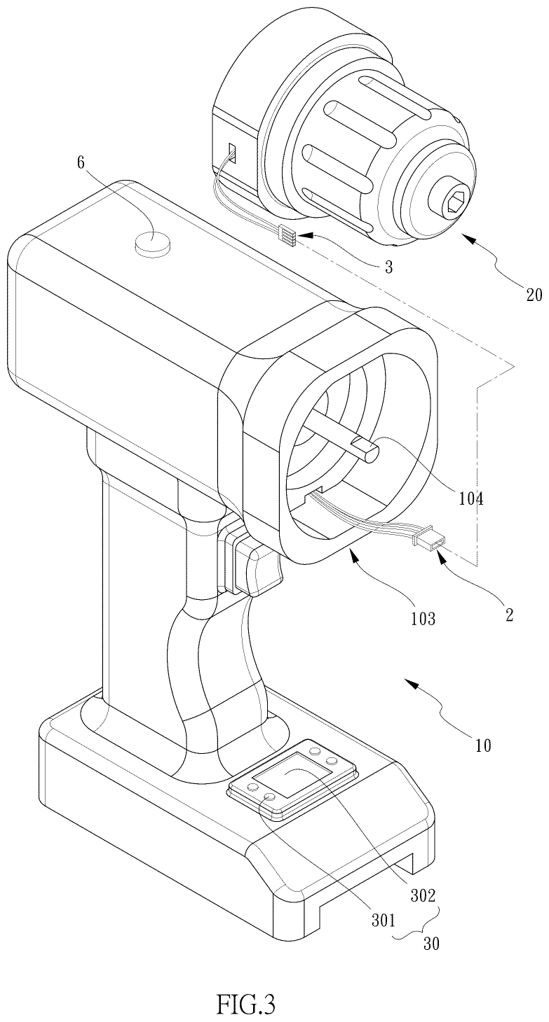

When the signal connection between the ID recognition module 2 and the ID module 3 is contact-based, the contact method can involve wire connection. That is to say, both the ID recognition module 2 and the ID module 3 are electrically connected with wires, with male and female plugs installed at the other ends of each wire. Signal transmission is achieved through the electrical connection between the male and female plugs. Finally, the signal is transmitted to the MCU control unit 1, matched with the multiple data messages 41 in the ID data unit 4, and upon completion of the matching process, the MCU control unit 1 can operate accordingly, as shown in FIG. 3.

In order to provide users with a clear indication before driving operations with interchangeable electric working heads 20, and let the users know whether the electric body 10 has adjusted the driving force to match the electric working head 20 after detecting and sensing, the present invention further includes a shortcut function button module 6 installed on the electric body 10. The shortcut function button module 6 is electrically connected to the MCU control unit 1. Through the operation of the function button in terms of the number of presses or the duration of presses, the MCU control unit 1 is activated and controls the output of corresponding data messages 41 from the ID data unit 4. In other words, the preset data and control processes are retrieved from the MCU storage with simple operation switching through the shortcut function button 6, and the drive unit 102 is directly adjusted for conversion, thereby improving work efficiency in repetitive and continuous tasks, as shown in FIG. 1 (corresponding to data messages built into the data unit, such as output shaft power, torque, and prescribed timing for increasing or decreasing or initiating brake procedure modes), and then the MCU control unit 1 controls the corresponding power output of the output shaft. (For example, when riveting, the process involves first activating force to pull the rivet, then braking, and finally reversing to retract the rivet core).

The present invention further includes an LCD display setting button module 30. The LCD display setting button module 30 includes a liquid crystal display screen 302 and multiple buttons 301 electrically connected to the MCU control unit 1. The LCD display setting button module 30 is designed such that upon pressing each button 301, corresponding parameters and values are displayed. Moreover, each button 301 allows for additional adjustment, setting, and fine-tuning of the multiple data messages 41. Thus, users can use the data presented by the LCD display setting button module 30 to understand whether the current driving force adjusted by the electric body 10 matches the electric working head 20 to be replaced. Furthermore, users can monitor and check for any errors in the driving force generated by the drive unit 102, and when errors occur or adjustments are needed during the operation or due to environmental changes, each button 301 can provide fine adjustments. This ensures that the electric body 10 can provide more precise driving force to operate the electric working head 20, as shown in the first figure.

Finally, in order to make the present invention more intelligent, after the aforementioned fine adjustments, in order to provide the ability to continue using the adjusted mode in the future, a data storage unit 5 is further built into the ID data unit 4. After adjusting and setting each data message 41 using the buttons 301, they can be additionally stored in the data storage unit 5. This allows for quick selection of electric working heads 20 with the same driving force in the future, providing users with a faster selection process without the need for further adjustment or setting, as shown in FIG. 1.

While we have shown and described the embodiment in accordance with the present invention, it should be clear to those skilled in the art that further embodiments may be made without departing from the scope of the present invention.

What is claimed is:

1. An intelligent identification device for handheld interchangeable power tools, comprising:
an MCU control unit (1) installed within an electric body (10), the electric body (10) including a power supply unit (101) and a drive unit (102), the MCU control unit (1) electrically connected to the power supply unit (101) and the drive unit (102), the power supply unit (101) providing power to the MCU control unit (1) and the drive unit (102), the MCU control unit (1) controlling and adjusting an output power of the drive unit (102);
an ID recognition module (2) connected to a connecting end (103) of the electric body (10), the ID recognition module (2) electrically connected to the MCU control unit (1);
an ID module (3) installed to an electric working head (20), the electric working head (20) detachably assembled to the connecting end (103) of the electric body (10), the drive unit (102) operatively engaged with the electric working head (20) and driving the electric working head (20), wherein the ID module (3) and the ID recognition module (2) are signally disconnected or connected according to detachment or assembly of the electric working head (20) relative to the connecting end (103), and
an ID data unit (4) located within the electric body (10) and electrically connected to the MCU control unit (1), the ID data unit (4) including multiple data messages (41), each data message (41) representing drive data for different types of electric working heads (20);
wherein, when different types of electric working heads (20) are replaced and installed at the connecting end (103) of the electric body (10), the ID module (3) of each electric working head (20) is signally connected to the ID recognition module (2), the ID recognition module (2) sends a generated signal to the ID data unit (4) through the MCU control unit (1) for judgment and recognition, the ID data unit (4) selects a matching data, and the drive unit (102) is powered and driven according to the selected matching data through the MCU control unit (1).

2. The intelligent identification device for handheld interchangeable power tools as claimed in claim 1, wherein a signal connection between the ID recognition module (2) and the ID module (3) is non-contact, and is a wireless radio frequency identification system (RFID), NearFi coupler, or NSD position sensor, through the non-contact signal connection, the ID module (3) stores different ID values, and the ID recognition module (2) recognizes the ID values through a non-contact sensing process, the MCU control unit (1) obtains recognition information during the non-contact sensing process.

3. The intelligent identification device for handheld interchangeable power tools as claimed in claim 1, wherein a signal connection between the ID recognition module (2) and the ID module (3) is contact-based, and is achieved by wire connection to transmit signals, a recognition between the ID recognition module (2) and the ID module (3) utilizes resistance, capacitance, and inductance simulation and generates different electrical signals, or stores digital ID values in digital memory, recognition is processed through contact-based electrical connection between the ID recognition module (2) and the ID module (3).

4. The intelligent identification device for handheld interchangeable power tools as claimed in claim 1, wherein a shortcut function button module (6) is installed on the electric body (10), the shortcut function button module (6) is electrically connected to the MCU control unit (1), through control of the shortcut function button module (6), pressing times and an operation of short or long press matched with different modes within the MCU control unit (1) are controlled.

5. The intelligent identification device for handheld interchangeable power tools as claimed in claim 1, wherein an LCD display setting button module (30) is electrically connected to the MCU control unit (1), the LCD display setting button module (30) comprises multiple buttons (301) and an LCD display screen (302), when each button (301) is pressed, the LCD display screen (302) displays corresponding parameters or values, each button (301) makes adjustment and setting to the multiple data messages (41), and adjusted values are displayed on the LCD display screen (302).

6. The intelligent identification device for handheld interchangeable power tools as claimed in claim 5, the ID data unit (4) includes a database storage unit (5), after adjustments and settings of the various data messages (41) by each button (301), the adjustments and settings of the various data messages (41) are stored within the database storage unit (5).
